(19) United States
(12) Patent Application Publication
(10) Pub. No.: US 2007/0080862 A1
(43) Pub. Date: Apr. 12, 2007

(54) Method for operating an antenna assembly

(76) Inventors: Bernd Biehlman, Ludwigsburg (DE); Heinrich Gotzig, Heilbronn (DE); Frank Kuenzler, Kraichtal (DE); Uwe Papziner, Bietigheim-Bissingen (DE); Udo Haberland, Holzgerlingen (DE)

Correspondence Address: DREISS, FUHLENDORF, STEIMLE & BECKER, POSTFACH 10 37 62, D-70032 STUTTGART, DE

(21) Appl. No.: 10/577,835

(22) PCT Filed: Sep. 28, 2004
(86) PCT No.: PCT/EP04/10826

§ 371 Date: May 1, 2006

(30) Foreign Application Priority Data
Nov. 8, 2003 (DE) 103 52 281.6

(51) Int. Cl. G01S 5/04; H01Q 3/00

(52) U.S. Cl. 342/433; 342/432; 342/373

(57) ABSTRACT

A method for operating an antenna assembly (100) produces a desired overall directional dependence. The antenna assembly (100) comprises at least one first partial antenna (R1) and a second partial antenna (R1+R2), which are disposed relative to each other in such a manner that the individual directional dependences of the partial antennas at least partially overlap. The first partial antenna (R1) is associated with a first antenna signal which represents a radio signal for receiving or transmitting via the first partial antenna (R1), and the second partial antenna (R1+R2) is associated with a second antenna signal which represents a radio signal for receiving or transmitting via the second partial antenna. Through cyclic, alternating operation of the first and second partial antennas, a third antenna signal can be generated which represents the radio signal for receiving or transmitting through the antenna assembly (100) and with the desired overall directional dependence via overlapping, individual directional dependences of the partial antennas (R1, R1+R2). The third antenna signal is generated through mathematical linking of the first and second antenna signals—.

The invention concerns a method for operating an antenna assembly with a particular overall directional dependence. The invention also concerns a computer program for performing this method, and an associated antenna assembly.

Antenna assemblies comprising at least one first and one second partial antenna are known in the art. The partial antennas are disposed relative to each other in such a manner that their individual directional dependences at least partially overlap. The first partial antenna has an associated first antenna signal which represents receipt or transmission of a radio signal via the first partial antenna. Analogous thereto, the second partial antenna has an associated second antenna signal which represents receipt or transmission of the radio signal via the second partial antenna. Conventional antenna assemblies of this type are realized, in particular, in the form of microstrip antennas, wherein the partial antennas are each formed by arrays each of which has a plurality of antenna elements (patches).

In antenna arrays of this type, a narrow lobe directional dependence is typically formed by designing the antenna assemblies to have a plurality of partial antennas extending over a large surface. The partial antennas are simultaneously operated, wherein spatially overlapping, individual directional dependences of the individual partial antennas combine to produce the narrow lobe of the overall antenna assembly.

Departing therefrom, it is the underlying object of the present invention to provide a method and a computer program for operating an antenna assembly with a desired overall directional dependence, and an antenna assembly of this type, which permit generation of narrow lobe directional dependences, thereby requiring considerably less space and less cost compared to prior art.

This object is achieved by the method claimed in claim 1. This method is characterized by the following steps: cyclic alternating operation of the first and second partial antennas and generation of a third antenna signal which represents the radio signal of receipt or transmission via the antenna assembly having the desired directional dependence due to the overlapping individual directional dependences of the partial antennas and generated through mathematically linking the first and the second antenna signals.

In contrast to prior art, the individual partial antennas of the present invention are not operated simultaneously, rather with a time offset. Their directional dependences are therefore not spatially superimposed at the same time. Instead, in accordance with the invention, a constructed overlapping is generated via a mathematical link of the respective antenna signals of the individual partial antennas. This is advantageous in that negative overlapping portions of the overall directional dependence can also be taken into consideration in a simple manner, i.e. through subtraction of the antenna signal of the corresponding partial antenna during generation of the overall dependence. In contrast to prior art, the claimed method permits, in particular, generation of desired overall directional dependences with narrow lobes without requiring great space or expense.

The frequency for switching between the individual partial antennas is advantageously selected via the dynamics of the radio signal, such that essential parts of the radio signal can be detected not only by one partial antenna but by each of the partial antennas, however, with a time offset.

The above-mentioned object is also achieved by a computer program and an antenna array for performing the claimed method. The advantages of these two solutions correspond substantially to the advantages mentioned above in connection with the claimed method. Moreover, it should be emphasized that at least one of the partial antennas comprises two parallel rows of antenna elements which are preferably disposed at a separation of λ/2 from each other. An assembly of this type is advantageous in that otherwise occurring side lobes are completely suppressed in the overall dependence.

The description includes a total of four figures, wherein

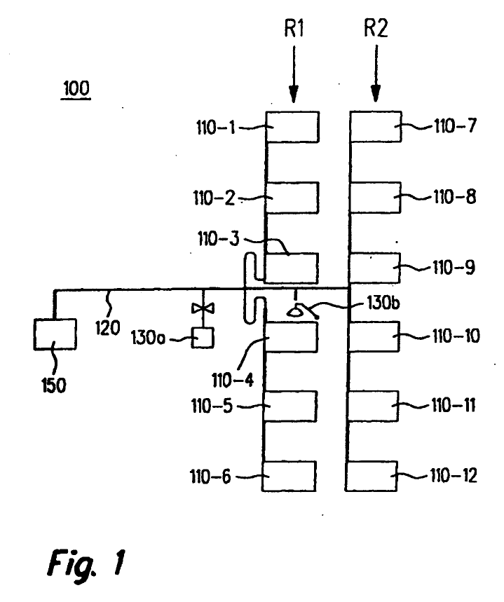

FIG. 1 shows an embodiment of the inventive antenna assembly;

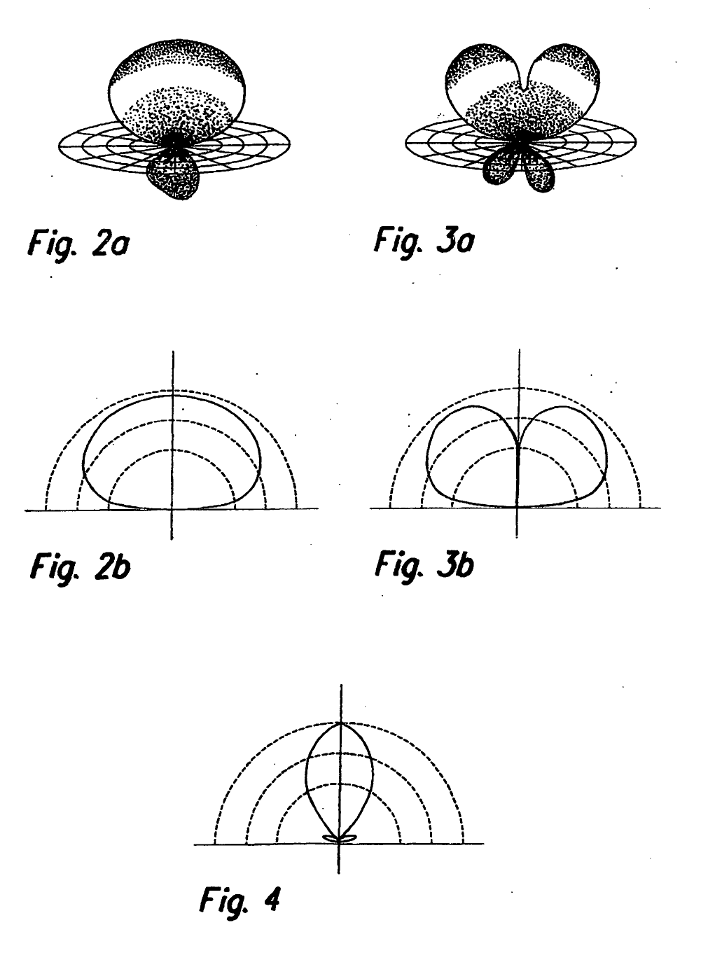

FIGS. 2a and 2b show an example for a first individual directional dependence of a first partial antenna;

FIGS. 3a and 3b show a second individual directional dependence of a second partial antenna; and

FIG. 4 shows an example of an overall directional dependence of the antenna assembly in accordance with the invention.

The invention is described in more detail below in an embodiment with reference to the above-mentioned FIGS. 1 through 4.

FIG. 1 shows an embodiment of the inventive antenna assembly 100. It comprises a first partial antenna with a total of six individual antenna elements 110-1 . . . 6, so-called patches. The individual patches are spatially disposed in one row R1 (FIG. 1) and are connected in parallel. The first partial antenna is symmetrical with respect to a line 120. Via this line 120, the overall antenna assembly and, in particular, the partial antennas are connected to a transmission and receiving unit comprising an evaluation means (150).

In a first operating mode, in which the antenna assembly 100 is operated merely with the first partial antenna 110, only the above-mentioned antenna elements 110-1 . . . 6 are activated. Alternatively or with cyclic alternation, the antenna assembly 100 can also be operated in a second operating mode with only one second partial antenna. This second partial antenna may be formed and disposed either completely separately from the first partial antenna or it consists of the first partial antenna (FIG. 1) with further connected antenna elements 110-7 . . . -12. Connection is performed via a control means comprising a control voltage source 130a and a suitable switching means 130b. In the embodiment of FIG. 1, the connected antenna elements 110-7 . . . -12 are also electrically connected in parallel and are spatially disposed in a second row R2, preferably parallel to the first row.

The inventive antenna assembly is preferably a microstrip patch antenna, with the individual antenna elements 110-1 . . . -12 constituting the so-called patches.

The function of the antenna assembly shown in FIG. 1 is described in more detail below with reference to FIGS. 2 through 4. FIGS. 2a and b show the individual directional dependence of the first partial antenna comprising the first row R1 of antenna elements in accordance with FIG. 1. This is a wide directional dependence, i.e. a directional dependence with wide coverage. In contrast thereto, FIGS. 3a and b show the individual directional dependence of the second partial antenna, i.e. with the first and second rows R1, R2 of antenna elements being operated simultaneously, wherein the two rows are disposed at a spatial separation from each other of preferably λ/2. The electrical separation is an uneven multiple of 180°. This produces the desired notch in the individual directional dependence of the second partial antenna (FIGS. 3a and 3b).

FIGS. 2b and 3b differ from FIGS. 2a and 3a merely in that the former show a perspective view and the latter each show a plan view of the same directional dependence. The desired overall directional dependence with narrow lobe is realized in accordance with the invention in that the two partial antennas R1, R1+R2 are operated alternately and their respective antenna signals are mathematically linked, in particular subtracted. Due to the alternating or time-offset operation of the partial antennas, their individual directional dependences do not actually overlap. In accordance with the invention, the overlap is generated by the above-mentioned mathematical link.

The overall directional dependence resulting from the mathematical link and using the individual directional dependences of the partial antennas (FIGS. 2 and 3) is shown in FIG. 4. It is a narrow dependence compared to the wider directional dependences shown in FIGS. 2 and 3. In accordance with the invention, the narrower dependence in accordance with FIG. 4 is generated using the two wider dependences only. The two wider dependences and the associated narrower, overall dependence are realized in accordance with the invention using the relatively simple and space-saving antenna assembly of FIG. 1. The narrow overall dependence of FIG. 4 can advantageously be generated using an antenna assembly having a smaller surface area and with less partial antennas than would be required according to prior art. The present invention saves both space and expense through omission of unnecessary partial antennas or antenna elements for generating a narrow directional dependence.

The principle according to the present invention applies for both receiving and transmitting antennas. It is suited both for narrow-band and for wide-band frequency operation.

The evaluation means 150 of the inventive antenna assembly performs this method. The inventive method is preferably realized in the form of a computer program, preferably for the evaluation means 150. The computer program may optionally be stored together with further computer programs on a computer-readable data carrier. The data carrier may be a disc, a compact disc, a flash memory or the like. The computer program stored on the data carrier may be sold as a product to a customer. The computer program may also be transmitted or sold to a customer in the form of a product without being stored on a data carrier, via an electronic communications network, in particular, the Internet.

1-10. (canceled)

11. A method for operating an antenna system having a desired overall directional dependence, the antenna system having at least one first partial antenna and a second partial antenna, the first and second partial antennas being disposed relative to each other in such a manner that individual directional dependences of the first and second partial antennas at least partially overlap, wherein the first partial antenna has a first antenna signal which represents a radio signal for receiving or transmitting via the first partial antenna, and the second partial antenna has a second antenna signal which represents a radio signal for receiving or transmitting via the second partial antenna, the method comprising the steps of:
a) cyclically alternating operation of the first and second partial antennas; and
b) generating a third antenna signal, which represents a radio signal for receiving or transmitting via the overall antenna system having the desired directional dependence, through overlapping of individual directional dependences of the first and second partial antennas, the third antenna signal being constructed through mathematical linking of the first and second antenna signals.

12. The method of claim 1, wherein the second partial antenna is generated from the first partial antenna by connecting at least one additional antenna element to the first partial antenna.

13. The method of claim 11, wherein a frequency for switching between the first and the second partial antennas is selected in accordance with dynamics of the radio signal to be sufficiently large such that each of the first and second partial antennas can equally receive similar parts of the radio signal.

14. An antenna system having a desired overall directional dependence, the system comprising:
at least one first partial antenna having a first antenna signal which represents a radio signal for receiving or transmitting via said first partial antenna;
a second partial antenna disposed relative to said first partial antenna in such a manner that individual directional dependences of said first and second partial antennas at least partially overlap, said second partial antenna having a second antenna signal which represents a radio signal for receiving or transmitting via said second partial antenna;
a control means for cyclic, alternating operation of said first and said second partial antennas; and
an evaluation means for generating a third antenna signal which represents a radio signal for receiving or transmitting via the overall antenna system with the desired directional dependence formed by overlapping, individual directional dependences of said first and second partial antennas, said third antenna signal generated through mathematical linking of said first and said second antenna signals.

15. The antenna system of claim 14, wherein said control means constructs said second partial antenna by operating said first partial antenna along with simultaneous operation of at least one additional antenna element.

16. The antenna system of claim 14, wherein said first partial antenna comprises a first plurality of antenna elements.

17. The antenna system of claim 16, wherein said first plurality of antenna elements are disposed in a first row.

18. The antenna system of claim 17, wherein said second partial antenna comprises a second plurality of antenna elements disposed in a second row.

19. The antenna system of claim 18, wherein said first and second rows are disposed parallel to each other.

20. The antenna system of claim 18, wherein said first and second rows of antenna elements have a mutual separation of λ/2.

21. The antenna system of claim 14, wherein the antenna system is a microstrip antenna.

22. A computer program having program code, designed to perform the method of claim 11.

23. A computer program having a program code for control of said evaluation means of the antenna system of claim 14.
